(19) United States
(12) Patent Application Publication
(10) Pub. No.: US 2025/0232658 A1
(43) Pub. Date: Jul. 17, 2025

(54) PANORAMIC FIRE SAFETY SYSTEM AND CONTROL METHOD THEREOF

(71) Applicant: NavCore Tech. Co., Ltd., Taoyuan City (TW)

(72) Inventors: Chi-chiang HSUEH, Taoyuan City (TW); Hsin-lung HSIEH, Taoyuan City (TW); Yu-hsuan LIAO, Taoyuan City (TW); Yan-qiao ZHANG, Taoyuan City (TW); Pang-tzu LIU, Taoyuan City (TW); Ting-ching YEN, Taoyuan City (TW)

(21) Appl. No.: 19/017,662

(22) Filed: Jan. 12, 2025

Related U.S. Application Data
(60) Provisional application No. 63/620,911, filed on Jan. 15, 2024.

(51) Int. Cl. G08B 17/12; G06V 10/764; H04N 23/698

(52) U.S. Cl. CPC G08B 17/125; G06V 10/764; H04N 23/698

(57) ABSTRACT

A panoramic fire safety system and a panoramic fire safety system control method are provided. The panoramic fire safety system is configured to assist monitors in analyzing a monitoring field. The panoramic fire safety system includes: a plurality of panoramic cameras, a plurality of sensors, a main system, and an authentication module. The main system includes: a disaster credit management module and an event detection module. The event detection module is connected to the disaster credit management module, and stores an abnormal condition. The main system identifies an abnormal situation in the monitoring field when a plurality of real-time images and a plurality of group environmental parameters grouped by the disaster credit management module meet the abnormal condition. The authentication module is connected to the main system and is configured as an interface between the main system and the access unit.

### CROSS-REFERENCE TO RELATED APPLICATIONS

The present application claims the priority of U.S. provisional Application No. 63/620,911, filed on Jan. 15, 2024, the disclosure of which is incorporated herein by reference in its entirely.

### FIELD OF INVENTION

The present application relates to a panoramic fire safety system and a control method of the panoramic fire safety system, in particular, a panoramic fire safety system and a control method of the panoramic fire safety system that analyze a state of a fire scene in real time in order to improve a search and rescue rate of the fire scene and to reduce a loss of property.

### BACKGROUND OF INVENTION

In the past, fire commanders had to go to the fire scene in person to perform their command duties and understand the situation and report back to the command center. Even so, there was still the problem that it was difficult to grasp the information on the fire scene directly. For example, it takes considerable time to communicate with key personnel: property managers, case managers, neighborhood leaders, and to identify the source of the fire and the cause of the incident, which results in a loss of time for the fire rescue, and consequently, a difficulty of searching and rescuing at the rescue site and the fire damage continue to increase.

In view of this, it is necessary to provide a panoramic fire safety system to solve the above technical problems.

### SUMMARY OF INVENTION

In order to solve the problems of the above-mentioned conventional technologies, the purpose of the present application is to provide a panoramic fire safety system that can analyze the fire scene status in real time to improve the fire search and rescue rate and to reduce the property losses.

In a first aspect, the present application provides a panoramic fire safety system configured to assist monitors in analyzing a fire scene, wherein the panoramic fire safety system comprises: a plurality of panoramic cameras configured to record a plurality of real-time images of the fire scene; a plurality of sensors configured to sense a plurality of environmental parameters of the fire scene; a main system connected to the plurality of panoramic cameras, wherein the main system comprises: a fire trust management module connected to the plurality of sensors, wherein the fire trust management module is configured to classify the plurality of environmental parameters into a plurality of sets of environmental parameters according to types of the plurality of environmental parameters; an event detection module connected to the fire trust management module, wherein the event detection module stores an abnormal condition and receives the plurality of real-time images and the plurality of sets of environmental parameters, wherein the main system identifies an abnormal situation occurs in the fire scene when the plurality of real-time images and the plurality of sets of environmental parameters meets the abnormal condition; and an authentication module connected to the main system and configured as an interface between the main system and an external unit, wherein the authentication module assigns the external unit access to data of the abnormal situation in the main system after the authentication module identifying the external unit.

In some embodiments of the present application, the fire trust management module is also configured to compare in advance whether the values of each set of environmental parameters are abnormal, and wherein an abnormal set of environmental parameters is marked by the fire trust management module.

In some embodiments of the present application, the main system further comprises: a video playing module connected to the event detection module and configured to display the plurality of real-time images; and a camera management module connected to the video playing module, wherein the camera management module is configured to monitor statuses of the plurality of panoramic cameras, and wherein control signals for controlling the plurality of panoramic cameras are transmitted to the plurality of panoramic cameras through the video playing module.

In some embodiments of the present application, the main system further comprises: a video playing module connected to the event detection module, and wherein the video playing module is configured to display the plurality of real-time images and store the plurality of real-time images; and a scene management module configured to have a field diagram, wherein the plurality of real-time images and the plurality of sets of environmental parameters are marked on the field diagram through the scene management module; wherein the field diagram after marked is presented through the video playing module.

In some embodiments of the present application, the event detection module is further connected to an abnormality notification module, wherein the abnormality notification module transmits a notification message to the outside when the abnormal situation occurs.

In some embodiments of the present application, the main system further comprises an image storage module connected to the event detection module, wherein the image storage module stores an abnormal situation video transmitted from the event detection module when the abnormal situation occurs.

In some embodiments of the present application, the event detection module is further connected to an abnormality notification module, and wherein the abnormality notification module is further connected to the image storage module, and wherein the abnormality notification module transmits a notification message to an outside of the main system and then transmits the abnormal situation image to the image storage module when the abnormal situation occurs.

In some embodiments of the present application, the event detection module is connected to the plurality of panoramic cameras through an audio and video transmission and reception module, and wherein the event detection module is connected to the fire trust management module through a data transmission and reception module.

In some embodiments of the present application, the plurality of sensors are connected to the main system through a fire trust system configured to classify statuses of the plurality of sensors.

In some embodiments of the present application, the main system further comprises a notification system, and wherein the event detection module further identifies the abnormal situation based on a notification signal of the notification system, and wherein the event detection module further transmits a notification message to an outside of the main system through the notification system when the abnormal situation occurs.

In a second aspect, the present application also provides a panoramic fire safety system control method to assist a monitor in analyzing a fire scene, wherein the panoramic fire safety system control method comprises: recording a plurality of real-time images of the fire scene by using a plurality of panoramic cameras; sensing a plurality of environmental parameters of the fire scene by a plurality of sensors; using a main system to connect the plurality of panoramic cameras, wherein the main system comprises a fire trust management module and an event detection module: classifying the plurality of environmental parameters into a plurality of sets of environmental parameters according to types of the plurality of environmental parameters by the fire trust management module; receiving the plurality of real-time images and the plurality of sets of environmental parameters by the event detection module, and wherein the main system identifies an abnormal situation occurs in the fire scene when the plurality of real-time images and the plurality of sets of environmental parameters meets the abnormal condition; and assigning an external unit access to data of the abnormal situation in the main system after an authentication module identifying the external unit.

Compared with the prior art, the present application provides a panoramic fire safety system and a panoramic fire safety system control method, which installing a plurality of panoramic cameras and a plurality of sensors in the fire scene, the main system classifies the plurality of environment parameters sensed by a plurality of sensors in advance by a fire trust management module and identify whether abnormal situation have occurred in different areas of the fire scene corresponding to the plurality of sets of environmental parameters and the real-time images. Therefore, fire risks in different areas of the same fire scene can be recorded and perceived differently, so that the present application can simultaneously achieve the technical effect of reducing the computational burden of the event detection module and improving the efficiency of identifying the cause of fire.

In addition, the present application uses the fire trust management module to pre-judge the differences of each group of environmental parameters at different time points when classifying the sets of environmental parameters, thereby pre-judging whether each set of environmental parameters is abnormal and annotating the abnormal environmental parameters set, to improve the prediction accuracy of abnormal events and gain more rescue time for fire incidents.

Furthermore, the present application sets up an authentication module between an external unit and the main system to identify the external unit that wants to access the data stored in the event detection module. The panoramic fire safety system provided by the present application can instantly identify external units and assign access rights when an emergency disaster occurs.

The purpose, technical content, characteristics and achieved effects of the present application will be more easily understood through detailed descriptions of specific embodiments and accompanying figures.

### DESCRIPTION OF FIGURES

FIG. 1 is a block diagram of a panoramic fire safety system according to one embodiment of the present application.

FIG. 2 is a block diagram of the panoramic fire safety system according to yet another embodiment of the present application.

FIG. 3 is a block diagram of the panoramic fire safety system according to yet another embodiment of the present application.

FIG. 4 is a block diagram of the panoramic fire safety system according to yet another embodiment of the present application.

FIG. 5 is a block diagram of the panoramic fire safety system according to yet another embodiment of the present application.

FIG. 6 is a block diagram of the panoramic fire safety system according to yet another embodiment of the present application.

FIG. 7 is a block diagram of the panoramic fire safety system according to yet another embodiment of the present application.

FIG. 8 is a schematic flow chart of the panoramic fire safety system control method according to one embodiment of the present application.

FIG. 9 is a schematic flow chart of the panoramic fire safety system control method according to yet another embodiment of the present application.

FIG. 10 is a schematic flow chart of the panoramic fire safety system control method according to yet another embodiment of the present application.

### DETAILED DESCRIPTION OF EMBODIMENTS

The technical solutions in the embodiments of the present application will be clearly and completely described below in conjunction with the accompanying figures in the embodiments of the present application. Obviously, the described embodiments are only part of the embodiments of the present application, not all implementations. In addition, it should be understood that the specific embodiments described here are only used to illustrate and explain the present application, and are not used to limit the present application.

Please refer to the figures in the accompanying figures, where the same component symbols represent the same components.

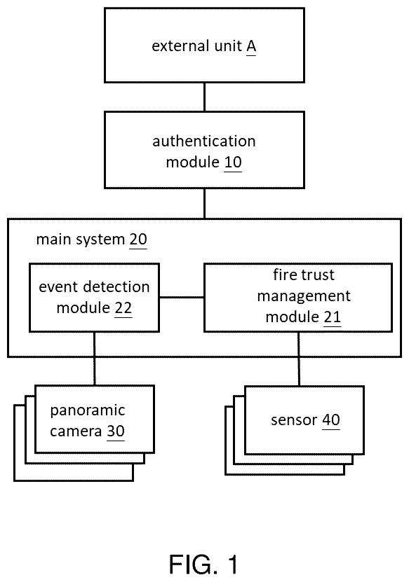

Referring to FIG. 1, FIG. 1 is a block diagram of a panoramic fire safety system according to one embodiment of the present application. The present application provides a panoramic fire safety system to assist monitors in analyzing a fire scene, including: a plurality of panoramic cameras 30 configured to record a plurality of real-time images of the fire scene; a plurality of sensors 40 configured to sense a plurality of environmental parameters of the fire scene; and a main system 20 connected to the plurality of panoramic cameras 30. The main system 20 includes: a fire trust management module 21 connected to the plurality of sensors, wherein the fire trust management module 21 is configured to classify the plurality of environmental parameters into a plurality of sets of environmental parameters according to the types of the plurality of environmental parameters; an event detection module 22 is connected to the fire trust management module 21, wherein the event detection module 22 stores an abnormal condition and receives the plurality of real-time images and the plurality of sets of environmental parameters, wherein the main system 20 identifies an abnormal situation occurs in the fire scene when the plurality of real-time images and the plurality of sets of environmental parameters meets the abnormal condition; and an authentication module 10 connected to the main system 20 and configured as an interface between the main system 20 and an external unit A, wherein the authentication module 10 assigns the external unit A access to data of the abnormal situation in the main system 20 after the authentication module 10 identifying the external unit A.

The authentication module 10 can be connected to more than one external unit A, and an authentication scheme executed requires at least the authentication module 10 to check the data of at least two external units A to identify the authority to access the abnormal data in the main system 20. For example, a first external unit A1 authorizes a set of authentication keys to be received by the authentication module 10, and a second external unit A2 is an external unit that wants to access the data of abnormal situations in the main system 20. The event detection module 22 transmits a group environment parameters and real-time screen data that meet the key conditions to the second external unit A2 when the second set of authentication keys transmitted by the second external unit A2 to the main system 20 meets the key conditions of the first set of authentication keys. Alternatively, the first external unit A1 authorizes a set of authentication keys to be received by the authentication module 10, the second external unit A2 authorizes a set of authentication keys to be received by the authentication module 10, and a third external unit A3 is an external unit that wants to access the abnormal situation data in the main system 20. The event detection module 22 transmits the group environment parameters and real-time screen data that meet the key conditions to the second external unit A2 when the access request transmitted by the third external unit A3 to the main system 20 meets the key conditions of the first set of authentication keys and the second set of authentication keys, to access group environment parameters and real-time screen data after achieving two-factor authentication.

The fire trust management module 21 classifies the set of each environmental parameter based on the sensing locations, sensing types of the plurality of environmental parameters, or a combination of the sensing locations and the sensing types of environmental parameters. For example, when the fire scene analyzed by the panoramic fire safety system is an interior and an exterior of a building, one set of environmental parameters records the temperature data on the third floor, and the other set of environmental parameters records the humidity data on the fourth floor, or, another set of environmental parameters is used to record the strength of the airflow between the ducts to the external vents. The data type of environmental parameters is not limited to humidity, temperature, or air flow intensity, which will not be described again here. The sensing data are grouped in advance through the fire trust management module 21. The event detection module 22 combines the received a plurality of sets of sensing data and a plurality of real-time images and displays them through the video playing module 23 when the event detection module 22 does not recognize that an abnormal condition occurs. Furthermore, since each set of environmental parameters corresponds to different locations, the set of environmental parameters identified by the event detection module 22 as a location where no abnormal situations occur is combined with a plurality of corresponding real-time images through the event detection module 22 and then displayed through the video playing module 23.

In one embodiment provided by the present application, the fire trust management module 21 is also configured to compare in advance whether the values of each set of environmental parameters are abnormal. The abnormal group environmental parameters are marked by the fire trust management module 21. The event detection module 22 performs special processing on the abnormal group environment parameters to ensure an operational stability of the main system 20 when the event detection module 22 receives the group environment parameters marked as abnormal. For example: Check again whether there are environmental parameters that cause abnormal parameters in the group environment parameters, and determine whether the environmental parameters that cause abnormal parameters belong to the organized exceptions or are exceptions to the organized exceptions. At the same time, the event detection module 22 continues to compare the same set of environmental parameters based on the exceptions to the sorted abnormal conditions, and then defines a parameter for tracking the exceptions to ensure system stability. Therefore, the abnormal conditions stored in the event detection module 22 can be generated based on sets of environmental parameters at different time points and internal comparisons of different sets of environmental parameters.

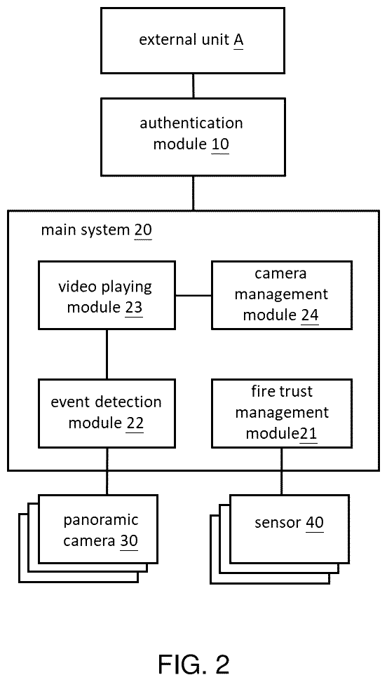

Continuingly, referring to FIG. 2, in one embodiment provided by the present application, the main system 20 further includes: a video playing module 23 connected to the event detection module 22, and configured to display a plurality of real-time images; and a camera management module 24 connected to the video playing module 23, wherein the camera management module 24 is configured to monitor statuses of the plurality of panoramic cameras 30, and wherein control signals for controlling the plurality of panoramic cameras 30 are output by the camera management module 24, and transmitted to the plurality of panoramic cameras 30 through the video playing module 23. The camera management module 24 is also configured to set the access authorities and picture output authorities of different panoramic cameras 30.

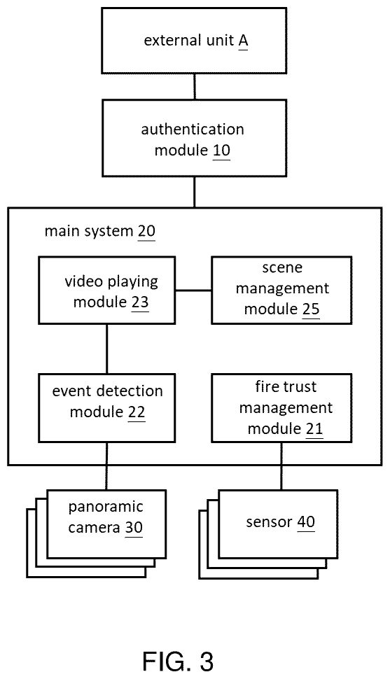

Referring to FIG. 3, in one embodiment provided by the present application, the main system 20 further includes: a video playing module 23. The video playing module 23 is connected to the event detection module 22. The video playing module 23 is configured to display the plurality of real-time images and store the plurality of real-time images. A scene management module 25 is configured to have a field diagram. The plurality of real-time images and the plurality of sets of environmental parameters are marked on the field diagram through the scene management module 25. The marked field diagram is presented through the video playing module 23. The scene management module 25 is also configured to add, delete, and modify the layout of the field and environmental parameters displayed on the video playing module 23 for authorized persons to review.

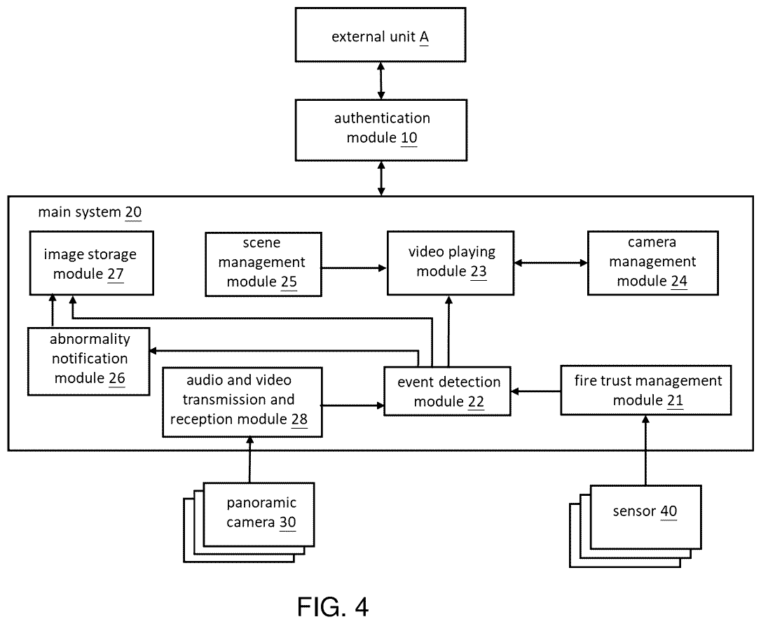

Referring to FIG. 4, in one embodiment provided by the present application, the event detection module 22 is further connected to an abnormality notification module 26. The abnormality notification module 26 transmits a notification message to an outside of the main system when the abnormal situation occurs. For example: The abnormality reporting module 26 sends the identified abnormality data and the predicted abnormality location and type to the external unit A when the event detection module 22 senses that an abnormal situation occurs.

The main system 20 further includes an image storage module 27 connected to the event detection module 22. The image storage module 27 stores an abnormal situation video transmitted from the event detection module 22 when the abnormal situation occurs, for the subsequent reference by external unit A.

The event detection module 22 is also connected to an abnormality notification module 26, and wherein the abnormality notification module 26 is further connected to the image storage module 27. The abnormality notification module 26 transmits a notification message to an outside of the main system and then transmits the abnormal situation image to the image storage module 27 when the abnormal situation occurs. In this embodiment, a priority of the data listed as abnormal situation images that need to be notified by the abnormality notification module 26 is improved, and its data retention time, retained image clarity, and number of combined sets of environmental parameters are all better than directly instructing the data stored in the image storage module 27 through the event detection module 22.

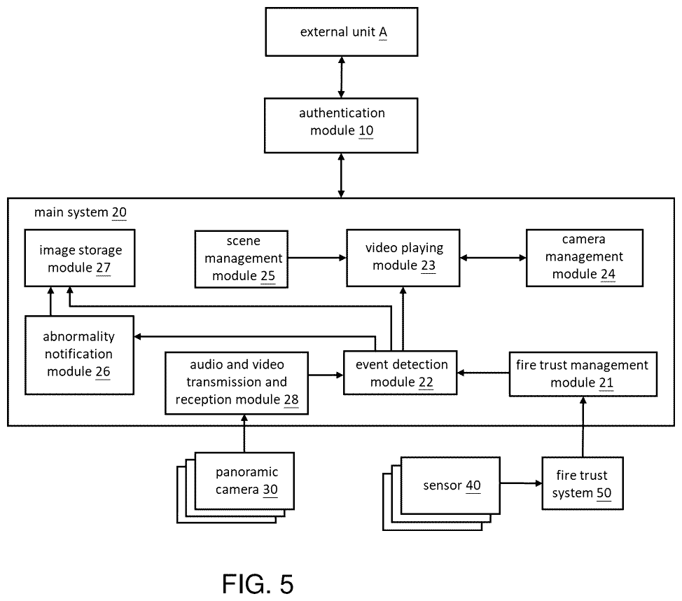

Referring to FIG. 5, in one embodiment provided by the present application, the event detection module 22 is connected to the plurality of panoramic cameras 30 through an audio and video transmission and reception module 28, thereby reducing the probability of accidental errors in the reception of the plurality of real-time images, thereby improving a module scalability of the panoramic cameras 30.

In one embodiment provided by the present application, the plurality of sensors 40 are connected to the main system 20 through a fire trust system 50 configured to classify statuses of the plurality of sensors 40, to ensure data consistency and data security between the addition of the sensor 40 and the main system 20 of the present application.

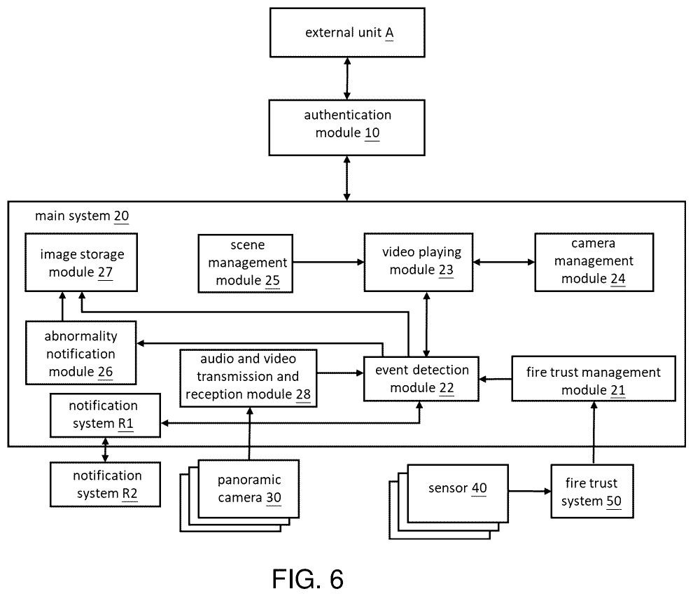

Referring to FIG. 6, in one embodiment provided by the present application, the main system 20 further includes a notification system R1 which connected to a notification system R2 set outside the main system 20. The event detection module 22 further identifies the abnormal situation based on the notification signals of the notification systems R1 and R2. The event detection module 22 further transmits a notification message to the outside of the main system 20 through the notification system R1 when an abnormal situation occurs. For example, the notification system R2 is installed inside the building, and the event detection module 22 notifies the personnel inside the building of an abnormal situation occurred and a current safe evacuation location through the notification system R1.

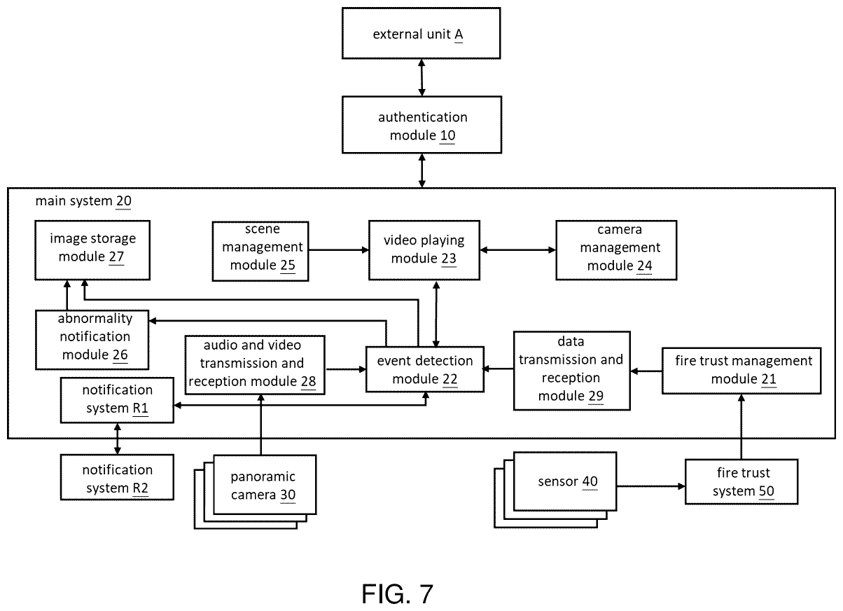

Referring to FIG. 7, in one embodiment provided by the present application, the event detection module 22 is connected to the fire trust management module 21 through a data transmission and reception module 29, thereby reducing a probability of accidental errors in environmental parameters, and improving module scalability.

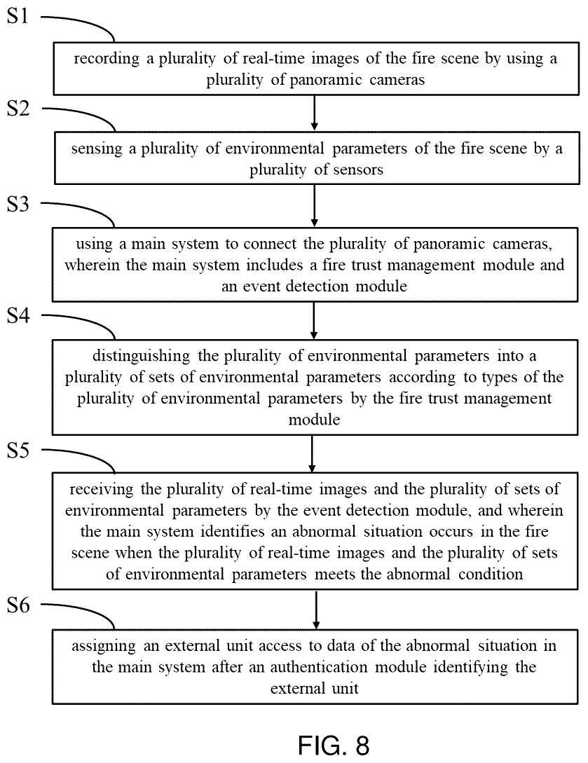

Please refer to FIG. 8, which is a schematic flow chart of a panoramic fire safety system control method according to one embodiment of the present application. The panoramic fire safety system control method provided by the present application includes:

S1: recording a plurality of real-time images of the fire scene by using a plurality of panoramic cameras.

By recording the plurality of real-time images of the fire scene through the plurality of panoramic cameras, when a fire occurs, even if one of the panoramic cameras is burned or obscured by thick smoke, the present application can still provide different display images to help fire commanders and fire command centers compare the current scene conditions in all aspects. In addition, it can also analyze a spread of fire by obtaining real-time images of different spaces in the same monitoring area. For example, a fire occurs in a building, and panoramic cameras are installed in the corridor space, firefighting space, escape entrances, and indoor or outdoor spaces of each floor. Or, the fire occurs inside a public transportation station, such as an MRT station, a train station, or a bus terminal, and the panoramic cameras are installed at an entrance or an exit or in a night waiting area or women's waiting area.

S2: sensing a plurality of environmental parameters of the fire scene by a plurality of sensors.

The types of sensors can be different sensors, such as: indoor carbon dioxide concentration sensor, oxygen sensor, water vapor sensor, and water level sensor of water storage system, etc.

S3: using a main system to connect the plurality of panoramic cameras, wherein the main system includes a fire trust management module and an event detection module.

S4: distinguishing the plurality of environmental parameters into a plurality of sets of environmental parameters according to types of the plurality of environmental parameters by the fire trust management module.

S5: receiving the plurality of real-time images and the plurality of sets of environmental parameters by the event detection module, and wherein the main system identifies an abnormal situation occurs in the fire scene when the plurality of real-time images and the plurality of sets of environmental parameters meets the abnormal condition.

By combining the aforementioned fire trust management module 21 and the event detection module 22, when a fire or fire safety event occurs and the event detection module 22 receives a set of environment parameters marked as abnormal, the event detection module 22 invests computing resources into the abnormal group environmental parameters to ensure an operational stability of the main system 20. In addition, by distributing analyzing environmental parameters through the fire trust management module 21 and the event detection module 22, even if some environmental parameters and real-time images cannot be received due to equipment damage during the fire, the panoramic fire safety system control method provided by the present application can still ensure that the fire trust management module 21 compares the received sensing data at different time points to predict the current conditions of different burning locations, providing a most appropriate fire status assessment and gain more rescue time for fire rescue.

S6: assigning an external unit access to data of the abnormal situation in the main system after an authentication module identifying the external unit.

By identifying at least one external unit A through the authentication module 10, or exchanging authentication information and authorization rights of a plurality of external units, the panoramic fire safety system control method provided by the present application can enable external unit A to authenticate and obtain abnormal situation information in a timely manner through the authentication module 10 when a fire occurs, thereby improving a rescue efficiency of collaboration between different external units.

In yet another embodiment provided by the present application, the fire trust management module is further configured to compare in advance whether the values of each set of environmental parameters are abnormal, and wherein an abnormal set of environmental parameters is marked by the fire trust management module 21.

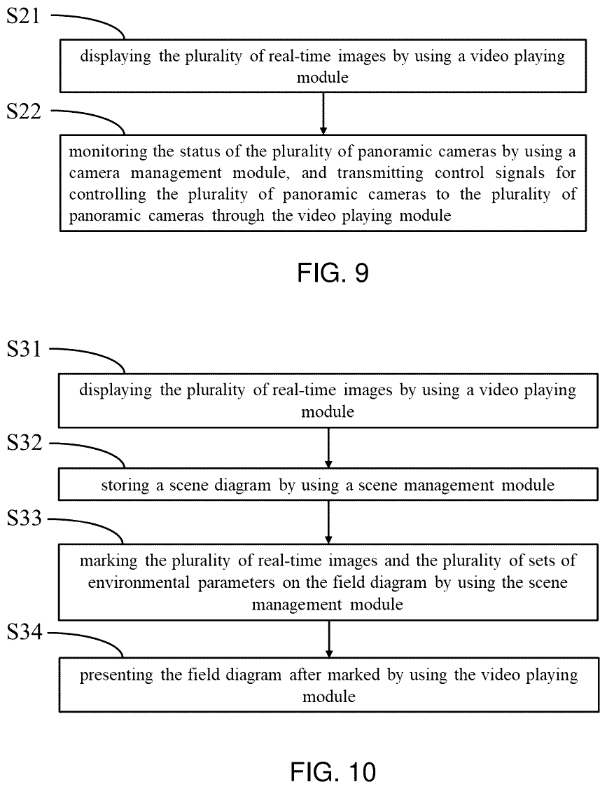

Please refer to FIG. 9. FIG. 9 is a schematic flow chart of the panoramic fire safety system control method according to one embodiment of the present application.

S21: displaying the plurality of real-time images by using a video playing module.

S22: monitoring the status of the plurality of panoramic cameras by using a camera management module, and transmitting control signals for controlling the plurality of panoramic cameras to the plurality of panoramic cameras through the video playing module.

Thus, the binding and adjustment of the camera can be managed through the camera management module 24 without the need to add other signal sharing when the video playing module 23 displays an abnormality. The signal transmission path can also be simplified to transmitting the information back to the event detection module 22 through the image management module 23 at the same time. Therefore, the present application can provide a simpler panoramic fire safety system control method.

Please refer to FIG. 10. FIG. 10 is a schematic flow chart of a panoramic fire safety system control method according to one embodiment of the present application, which includes:

S31: displaying the plurality of real-time images by using a video playing module.

S32: storing a scene diagram by using a scene management module.

S33: marking the plurality of real-time images and the plurality of sets of environmental parameters on the field diagram by using the scene management module.

S34: presenting the field diagram after marked by using the video playing module.

In this way, the scene management module 25 can cooperate with the video playing module 23 to complete the bonding of the field diagram with the currently real-time images and environmental parameters.

In one embodiment provided by the present application, the panoramic fire safety system control method further includes: storing an abnormal situation video transmitted from the event detection module 22 by using an image storage module 27. Thereby, the event detection module 22 does not need to occupy excessive storage resources, and when subsequent trace evidence review is required, the abnormal data that has occurred can be reviewed through the image storage module 27 to analyze the cause of the accident.

In yet another embodiment provided by the present application, the panoramic fire safety system control method further includes: transmitting a notification message outside the main system 20 by the abnormality notification module 26 and then transmitting the abnormal situation image to the image storage module 27 through the abnormality notification module 26 when the abnormal situation occurs. In this way, a priority of the reported abnormal situation images can be increased after being marked by the abnormality reporting module 26, so that the present application can further improve the efficiency and data security of abnormality data retrieval, and ensure a retention of evidence of abnormality.

The present application has at least the following beneficial effects: The present application provides a panoramic fire safety system and a panoramic fire safety system control method. By installing a plurality of panoramic cameras and a plurality of sensors in the fire scene, the main system classifies the plurality of environment parameters sensed by a plurality of sensors in advance by a fire trust management module and identify whether abnormal situation have occurred in different areas of the fire scene corresponding to the plurality of sets of environmental parameters and the real-time images. Therefore, fire risks in different areas of the same fire scene can be recorded and perceived differently, so that the present application can simultaneously achieve the technical effect of reducing the computational burden of the event detection module and improving the efficiency of identifying the cause of fire. In addition, the present application uses the fire trust management module to pre-judge the differences of each group of environmental parameters at different time points when classifying the sets of environmental parameters, thereby pre-judging whether each set of environmental parameters is abnormal and annotating the abnormal environmental parameters set, to improve the prediction accuracy of abnormal events and gain more rescue time for fire incidents. Furthermore, the present application sets up an authentication module between an external unit and the main system to identify the external unit that wants to access the data stored in the event detection module. The panoramic fire safety system provided by the present application can instantly identify external units and assign access rights when an emergency disaster occurs.

It should be noted that the combination of various embodiment in the present application preferably forms the above-mentioned multiple embodiments, but this should not be interpreted as a limitation of the present application. That is, each element in the present application can be combined in more ways, and is not limited to the above-mentioned embodiments.

This specification uses specific examples to illustrate the principles and implementation methods of the present application. The description of the above embodiments is only used to help understand the technical solutions and core ideas of the present application. Those of ordinary skill in the art should understand that they can still modify the technical solutions recorded in the foregoing embodiments, or make equivalent substitutions for some of the technical features. These modifications or substitutions do not cause the essence of the corresponding technical solutions to depart from a scope of the technical solutions of the embodiments of the present application.

What is claimed is:

1. A panoramic fire safety system configured to assist monitors in analyzing a fire scene, wherein the panoramic fire safety system comprises:
a plurality of panoramic cameras configured to record a plurality of real-time images of the fire scene;
a plurality of sensors configured to sense a plurality of environmental parameters of the fire scene;
a main system connected to the plurality of panoramic cameras, wherein the main system comprises:
a fire trust management module connected to the plurality of sensors, wherein the fire trust management module is configured to classify the plurality of environmental parameters into a plurality of sets of environmental parameters according to types of the plurality of environmental parameters;
an event detection module connected to the fire trust management module, wherein the event detection module stores an abnormal condition and receives the plurality of real-time images and the plurality of sets of environmental parameters, wherein the main system identifies an abnormal situation occurs in the fire scene when the plurality of real-time images and the plurality of sets of environmental parameters meets the abnormal condition; and
an authentication module connected to the main system and configured as an interface between the main system and an external unit, wherein the authentication module assigns the external unit access to data of the abnormal situation in the main system after the authentication module identifying the external unit.

2. The panoramic fire safety system of claim 1, wherein the fire trust management module is also configured to compare in advance whether the values of each set of environmental parameters are abnormal, and wherein an abnormal set of environmental parameters is marked by the fire trust management module.

3. The panoramic fire safety system of claim 1, wherein the main system further comprises:
a video playing module connected to the event detection module and configured to display the plurality of real-time images; and
a camera management module connected to the video playing module, wherein the camera management module is configured to monitor statuses of the plurality of panoramic cameras, and wherein control signals for controlling the plurality of panoramic cameras are transmitted to the plurality of panoramic cameras through the video playing module.

4. The panoramic fire safety system of claim 1, wherein the main system further comprises:
a video playing module connected to the event detection module, and wherein the video playing module is configured to display the plurality of real-time images and store the plurality of real-time images; and
a scene management module configured to have a field diagram, wherein the plurality of real-time images and the plurality of sets of environmental parameters are marked on the field diagram through the scene management module;
wherein the field diagram after marked is presented through the video playing module.

5. The panoramic fire safety system of claim 1, wherein the event detection module is further connected to an abnormality notification module, wherein the abnormality notification module transmits a notification message to the outside when the abnormal situation occurs.

6. The panoramic fire safety system of claim 1, wherein the main system further comprises an image storage module connected to the event detection module, wherein the image storage module stores an abnormal situation video transmitted from the event detection module when the abnormal situation occurs.

7. The panoramic fire safety system of claim 6, wherein the event detection module is further connected to an abnormality notification module, and wherein the abnormality notification module is further connected to the image storage module, and wherein the abnormality notification module transmits a notification message to an outside of the main system and then transmits the abnormal situation image to the image storage module when the abnormal situation occurs.

8. The panoramic fire safety system of claim 1, wherein the event detection module is connected to the plurality of panoramic cameras through an audio and video transmission and reception module, and wherein the event detection module is connected to the fire trust management module through a data transmission and reception module.

9. The panoramic fire safety system of claim 1, wherein the plurality of sensors are connected to the main system through a fire trust system configured to classify statuses of the plurality of sensors.

10. The panoramic fire safety system of claim 1, wherein the main system further comprises a notification system, and wherein the event detection module further identifies the abnormal situation based on a notification signal of the notification system, and wherein the event detection module further transmits a notification message to an outside of the main system through the notification system when the abnormal situation occurs.

11. A panoramic fire safety system control method to assist a monitor in analyzing a fire scene, wherein the panoramic fire safety system control method comprises:
recording a plurality of real-time images of the fire scene by using a plurality of panoramic cameras;
sensing a plurality of environmental parameters of the fire scene by a plurality of sensors;
using a main system to connect the plurality of panoramic cameras, wherein the main system comprises a fire trust management module and an event detection module:
classifying the plurality of environmental parameters into a plurality of sets of environmental parameters according to types of the plurality of environmental parameters by the fire trust management module;
receiving the plurality of real-time images and the plurality of sets of environmental parameters by the event detection module, and wherein the main system identifies an abnormal situation occurs in the fire scene when the plurality of real-time images and the plurality of sets of environmental parameters meets the abnormal condition; and
assigning an external unit access to data of the abnormal situation in the main system after an authentication module identifying the external unit.

12. The panoramic fire safety system control method of claim 11, wherein the fire trust management module is further configured to compare in advance whether the values of each set of environmental parameters are abnormal, and wherein an abnormal set of environmental parameters is marked by the fire trust management module.

13. The panoramic fire safety system control method of claim 11, further comprising:
displaying the plurality of real-time images by using a video playing module; and
monitoring the status of the plurality of panoramic cameras by using a camera management module, and transmitting control signals for controlling the plurality of panoramic cameras to the plurality of panoramic cameras through the video playing module.

14. The panoramic fire safety system control method of claim 11, further comprising:
displaying the plurality of real-time images by using a video playing module;
storing a scene diagram by using a scene management module;
marking the plurality of real-time images and the plurality of sets of environmental parameters on the field diagram by using the scene management module; and
presenting the field diagram after marked by using the video playing module.

15. The panoramic fire safety system control method of claim 11, further comprising:
storing an abnormal situation video transmitted from the event detection module by using an image storage module.

16. The panoramic fire safety system control method of claim 15, further comprising:
transmitting a notification message outside the main system by an abnormality notification module and then transmitting the abnormal situation image to the image storage module through the abnormality notification module when the abnormal situation occurs.
